(19) United States
(12) Patent Application Publication
(10) Pub. No.: US 2005/0056611 A1
(43) Pub. Date: Mar. 17, 2005

(54) Baby bottles with sealing icons, integral handles and/or protective skirts

(76) Inventor: Nouri E. Hakim, Monroe, LA (US)

Correspondence Address: LAW OFFICE OF MORRIS E. COHEN, 1122 CONEY ISLAND AVENUE, SUITE 217, BROOKLYN, NY, 11230, US

(21) Appl. No.: 10/852,589

(22) Filed: May 24, 2004

Related U.S. Application Data
(62) Division of application No. 09/656,289, filed on Sep. 6, 2000, now abandoned.
(62) Division of application No. 29/119,049, filed on Feb. 23, 2000, now Pat. No. D454642.
(62) Division of application No. 29/088,360, filed on May 21, 1998, now Pat. No. D425994.
(60) Provisional application No. 60/152,655, filed on Sep. 7, 1999.

(30) Foreign Application Priority Data
Nov. 21, 1997 (FR) 976,785

(51) Int. Cl. A61J 9/00; A61J 9/08

(52) U.S. Cl. 215/11.6; 215/11.1; 215/396

(57) ABSTRACT

Baby bottles with a cover having an icon provided therein. The icon provides a sealing element on the bottom of the cover, preventing leakage from the bottle's nipple. In a further embodiment, a baby bottle cap includes a recess inside the cap and notches at the cap's sides, with a portion of the handle snapping into the recess and the notches. In a further embodiment, a skirt is provided to the baby bottle's bottom surface which acts as a reinforcing element, preventing breakage or cracking of the bottom of the bottle when dropped.

### RELATED APPLICATIONS

The present application is a divisional of U.S. Nonprovisional application Ser. No. 09/656,289 filed Sep. 6, 2000 (pending), which claims the priority of U.S. Provisional Application Ser. No. 60/152,655 filed Sep. 7, 1999; U.S. Design patent application Ser. No. 29/119,049 filed Feb. 23, 2000; U.S. Design patent application Ser. No. 29/088,360 filed May 21, 1998 (patented as U.S. Design Pat. No. D425,994 issued May 30, 2000); and French Design Patent No. 976,785 filed Nov. 21, 1997. The disclosures of all of those prior applications are fully incorporated herein by reference.

### FIELD OF THE INVENTION

The present invention relates to improved baby bottles, and to sealing icons, integral handles, and protective skirts for use therewith.

### SUMMARY OF THE INVENTION

In accordance with the present invention, new baby bottles are provided as described herein.

In a first embodiment of the present inventions, a baby bottle is provided having an icon therein. This icon consists of a button which is located at the top of the bottle's cover. The icon provides a sealing element preventing leakage from the bottle's nipple. When the cover is placed onto the bottle, the nipple of the baby bottle is pressed into the icon such that the orifice at the top of the nipple is pressed against, and thereby sealed by, the bottom of the icon. As a result, when the bottle is shaken, leakage out of the nipple is minimized or eliminated.

In a second embodiment of the present inventions, a new handle is provided for baby bottles. In accordance with the invention, the cap of the baby bottle has a recess provided therein with a portion of the handle fitting or locking into this recess. Preferably, the cap also has slits provided at its sides to further accommodate the protruding handles. As a result, the handles and the cap are integrated into a single unit, preventing the handle from rotating on the bottle and making it easier and quicker for the parent or other care giver to attach the handle and cap to the bottle as a single unit, rather than as separate elements.

In a third embodiment of the present inventions, a baby bottle is provided having a skirt provided thereon. This skirt consists of a cap placed on the bottom of the bottle. The skirt acts as a reinforcing element, preventing breakage or cracking of the bottom of the bottle when dropped.

Further objects and aspects of the inventions will become apparent in conjunction with the disclosure herein.

### BRIEF DESCRIPTION OF THE DRAWINGS

FIG. 1 is a series of views showing the combination of the icon, handles, and skirt of the present invention on a fully assembled baby bottle. FIG. 1a is a top view of the assembled bottle; FIG. 1b is a front view; FIG. 1c is a bottom view; FIG. 1d is a perspective view; and FIG. 1e is a cross-sectional view.

FIG. 2 is a series of views of the handle of the present invention in conjunction with the cap of a baby bottle, but without the nipple. FIG. 2a is a top view, FIG. 2b is a front, exploded view; FIG. 2c is a bottom view; and FIG. 2d is an exploded, cross-sectional view.

FIG. 3 is a series of views of the handle of the present invention attached to the cap of a baby bottle, with the cover and the nipple further attached to the cap, as well. The body of the bottle is not shown. FIG. 3a is a top view; FIG. 3b is a front view; FIG. 3c is a bottom view; and FIG. 3d is a cross-sectional view.

FIG. 4 is a series of views of the handle of the present invention attached to the cap of a baby bottle, with the nipple inserted into the cap as well. The cover of the bottle and the body of the bottle are not shown. FIG. 4a is a top view; FIG. 4b is a front view, FIG. 4c is a bottom view; and FIG. 4d is a cross-sectional view.

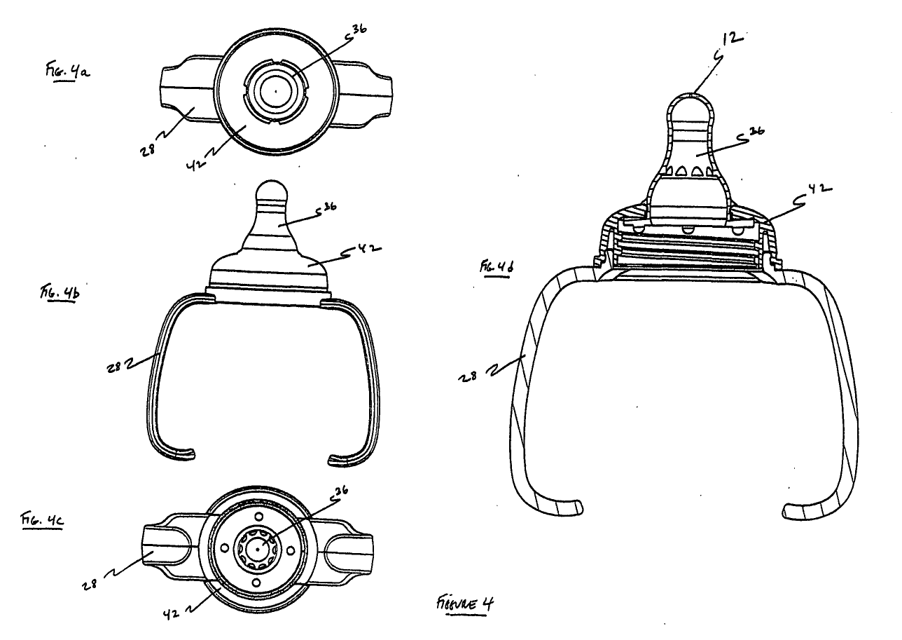

FIG. 5 is a series of views of the cover of a baby bottle, including the icon of the present inventions. The cover is attached to the cap with the nipple inserted into the cap and extending into the icon in accordance with the invention. The invention can be provided with handles, or can be without handles as is shown in the figure. FIG. 5a is a top view; FIG. 5b is a front view; FIG. 5c is a bottom view; and FIG. 5d is a cross-sectional view.

FIG. 6 is a series of views of the cover of a baby bottle, including the icon of the present invention. The figures show the attachment of the icon to the cover, and the insertion of the nipple into the cap. The invention can be provided with handles, or can be without handles as is shown in the figure. FIG. 6a is a top view; FIG. 6b is a front, exploded view; FIG. 6c is a bottom view; and FIG. 6d is an exploded, cross-sectional view.

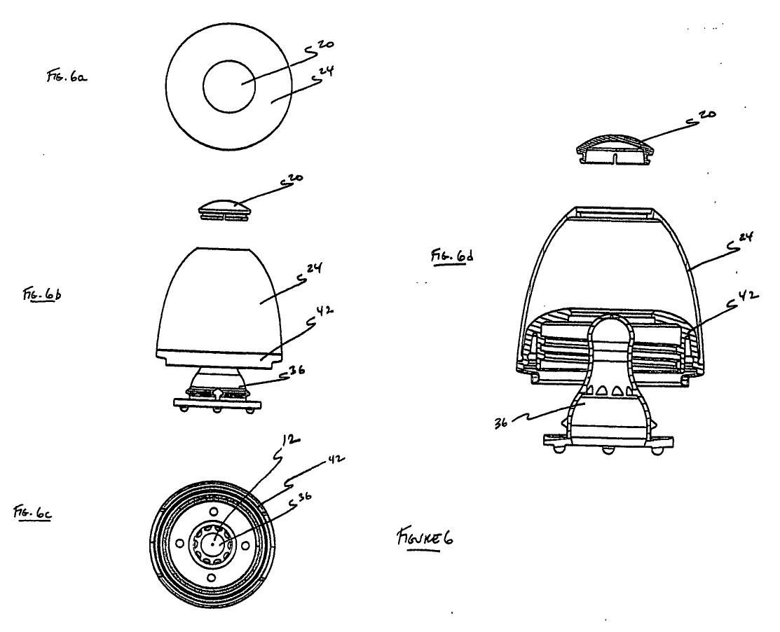

FIG. 7 is a series of views of an entire baby bottle assembly, with the icon, the handles, and the skirt of the present inventions all included therein. FIG. 7a is a front, exploded, view; and FIG. 7b is a side, exploded view.

FIG. 8 is a series of views of the skirt of the present invention. FIG. 8a is a side, exploded, view, FIG. 8b is a side view with the skirt attached to the bottom of the bottle; and FIG. 8c is a cross-sectional view with the skirt attached to the bottom of the bottle.

### DETAILED DESCRIPTION OF THE INVENTION AND THE PREFERRED EMBODIMENTS

As described below, several embodiments of inventions for baby bottles are provided herein. In accordance with the invention, any desired combination of these embodiments can be utilized in a single bottle. Thus, a baby bottle can be provided with any one of these embodiments, any two of these embodiments, or all three of these embodiments in combination. The components of the embodiments are preferably molded out of plastic or any other suitable material. Both the materials and molding techniques used can be any of the well known techniques for plastic bottle manufacture in general, including those used in the art of baby bottle manufacture in particular. In addition, the inventions can be provided to baby bottles of any size or shape, whether those having a conventional sized neck, a wide neck, or so forth.

In a first embodiment of the present invention, a baby bottle is provided having an icon therein. This icon consists of a button-like element which is located at the top of the bottle's cover. The icon acts as a sealing element, preventing leakage from the bottle's nipple.

It is, of course, well known that a nipple has holes or orifices 12 provided therein so that milk or other fluid can pass from the bottle through the nipple for the baby to drink. However, such holes can provide a leakage problem. When the bottle is shaken (whether by the baby or by the care giver), fluid is often forced or spilled out of the hole into the surrounding environment or into the bottle hood. In accordance with the present invention, such spillage is prevented.

Specifically, when a cover or hood having the icon of the present invention is placed onto the bottle, the nipple of the baby bottle is pressed into the icon, such that the orifice at the top of the nipple is pressed against, and thereby sealed by, the icon's bottom surface. As a result, when the bottle is shaken, leakage out of the nipple is minimized or eliminated.

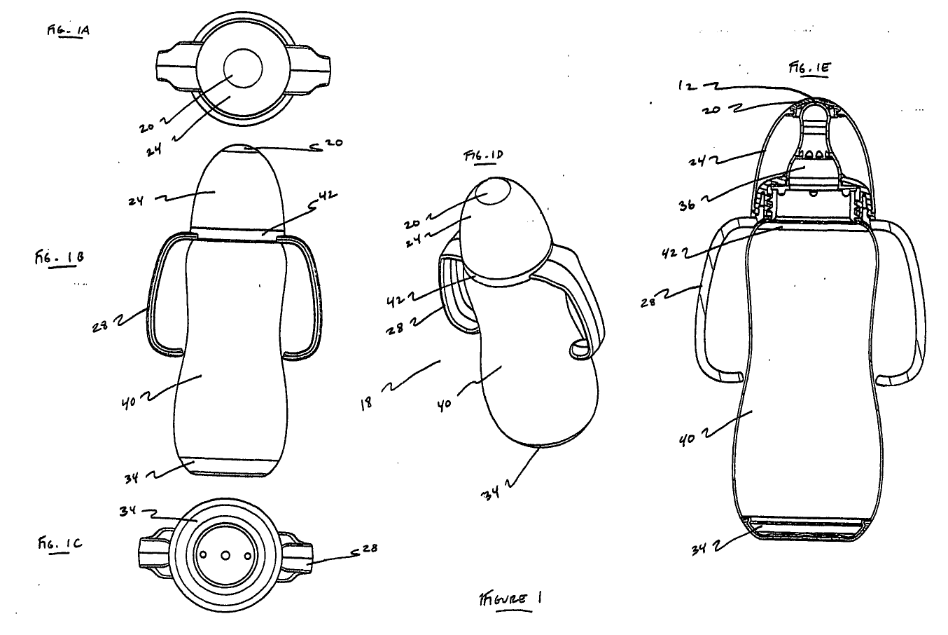

FIG. 1 is a series of views showing the combination of the icon, handles, and skirt of the present invention on a fully assembled baby bottle. As shown in the figure, a bottle is provided having a cover or hood 24 for covering the nipple 36 of the baby bottle. The bottom of cover 24 preferably fits snugly over cap 42 to form a tight fit. In the preferred embodiment, cover 24 is a dome-shaped cover as shown in the figures. In alternate embodiments, cover 24 can be any other desired shape, although it is preferably a shape which will fit over cap 42 and nipple 36. Cover or hood 24 can be clear or any desired color.

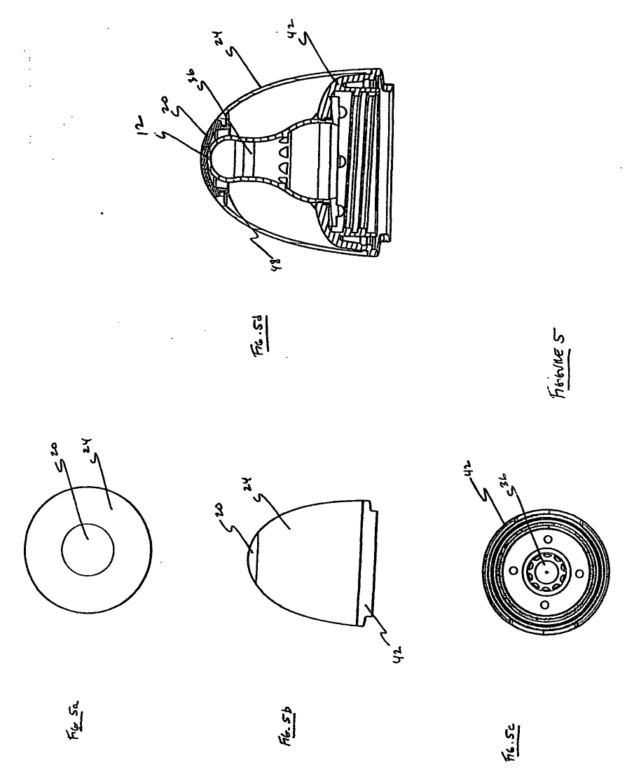

Icon 20 is a sealing element located at the top of cover 24 which is provided to prevent the nipple of the bottle from leaking. Preferably, the upper surface of the icon is round in shape. Further preferably, the upper surface of the icon is flush with the outer surface of cover 24, as shown in FIGS. 1e and 5d. The icon can either be an integral part of cover 24 or can be inserted into the cover using an appropriate molding process. In a preferred embodiment, icon 20 is a different color than the cover.

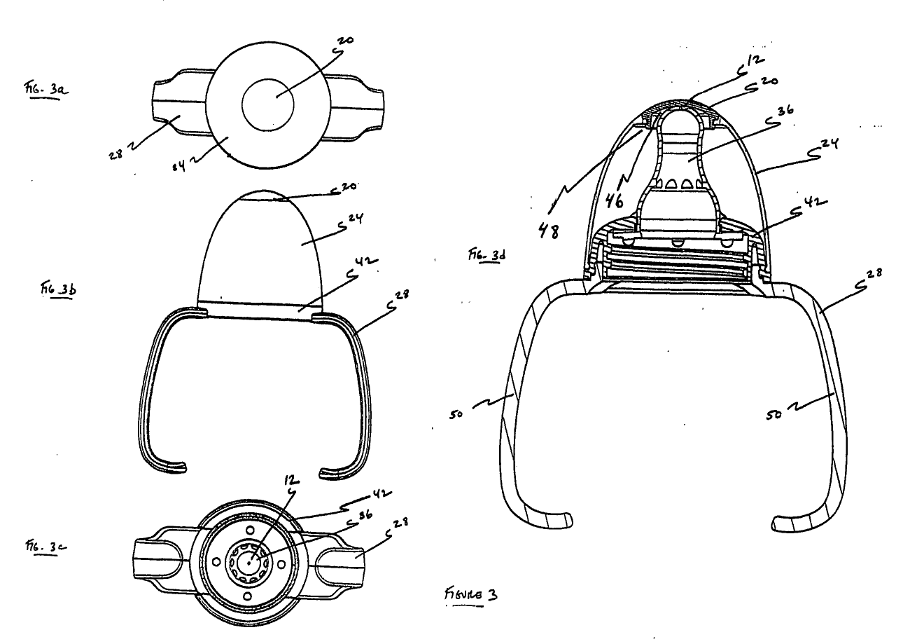

Icon 20 preferably further includes a rounded inner surface on the underside of the icon. In addition, the icon may be provided with an annular flange 48 on its bottom surface, as shown in FIG. 3d. This annular flange extends around the circumference of the icon's bottom surface, creating a raised border or edge between the icon and the inner surface of the cover. This border assists in capturing and containing the top of the nipple within the icon.

Further preferably, the bottom surface 46 of the icon, i.e. the surface which will come into contact with the nipple is rounded to approximately fit the shape of the top of the nipple. In other words, the bottom surface of the icon is preferably rounded so that it is contoured as a small dome at the top of the cover which will generally conform to the rounded top surface or tip of the nipple. This provides a secure seal between the nipple and the icon, as shown, for example, in FIG. 3d.

If desired, a tighter fit between the nipple and the shape of the bottom of the icon than shown in the drawings can, of course, be provided as well. However, it is preferred that the bottom surface of the icon not be too highly curved. Too tight a curvature (as would be provided, for example, if the bottom surface of the icon corresponded almost exactly to the shape and size of the nipple tip) can make it more difficult to insert the tip of the nipple into the bottom of the icon and to remove it therefrom.

When cover 24 is placed onto cap 42 while the cap has a nipple therein, icon 20 is pressed down onto the top of the nipple to tightly seal off the orifice or hole 12 in the nipple. In a preferred embodiment, the dimensions inside the cover from the bottom surface of the icon to the top of the cap are slightly less than the height of the nipple to further assist with this sealing effect.

This can be accomplished, for example, by appropriately adjusting the inside height of the cover and/or the thickness of the icon. For example, the inside height of the cover from the cap to the inner top of the cover can be slightly shorter in length than the height of the nipple above the bottle cap. Additionally or alternatively, the thickness of the icon can be increased to any desired dimension.

As a result, when the cover is placed onto the cap, the bottom of the icon will sufficiently press down against the top of the nipple so as to compress the nipple slightly, further dosing the orifice in the nipple and ensuring a tight and effective seal between the nipple and the icon. This compression causes the nipple's orifice to be sealed sufficiently tightly by the icon such that the bottle can be shaken or dropped, yet no liquid will emerge from the nipple into the snap on hood.

In the preferred embodiment, a sealing icon integrated into the cover is used to establish this sealing effect. In an alternate embodiment, the a cover without an icon can be used, wherein the dimensions of the cover are reduced sufficiently so as to establish the desired tight sea, as discussed above. However, an icon which is contoured to, and fits over, the top tip of the baby bottle nipple is preferred.

In a second embodiment of the present invention, a new handle is provided for baby bottles. Handles for baby bottles have previously been known in the art. In prior constructions, a ring is provided which fits over the bottle neck, with the ring having handles extending therefrom. The handles allows the child to more easily grasp the bottle during use. In prior constructions, however, such handles have been separate structures from the rest of the bottle. As a result, the handle can exhibit the undesirable property of sliding around the neck of the bottle during use. In addition, the fit between the handle and the bottle can be less than ideal.

To address these drawbacks in prior constructions, a new construction for a baby bottle handle is provided, as shown in the figures. In accordance with the present invention, the cap of the baby bottle has a recess or cavity provided therein, with a portion of the handle fitting or locking into this recess. In the preferred embodiment, the top of the handle snaps into the recess to form a secure fit. Further preferably, the cap also has slits or notches located at its sides to further accommodate the protruding handles. The slits or notches are provided as a cutaway portion of the sidewall of the cap, with the handle top fitting up into the notch. As a result, the handles and the cap are integrated into a single unit, preventing the handle from rotating on the bottle and making it easier and quicker for the parent or other care giver to attach the handle and cap to the bottle as a single unit, rather than as separate elements.

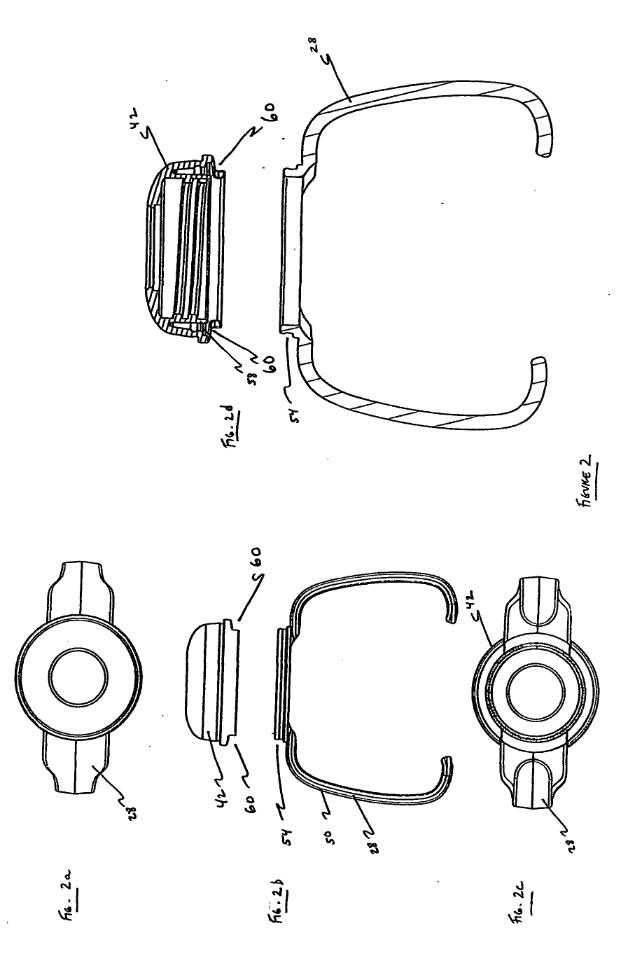

Handle 28 preferably consists of two gripping arms 50 extending down from the cap 42 along the sides of the body 40 of baby bottle 18 as shown in FIG. 1 and FIG. 2b. In the preferred embodiment, handle 28 includes a ring portion 54, such that the two gripping arms 50 are connected to and extend off of a central ring 54 to form the handle 28.

Preferably cap 42 includes an annular recess or channel 58 extending around the inside of cap 42 as shown in FIG. 2d. This recess or cavity is located between the outer surface of the cap, i.e. the surface of the cap visible to the consumer when the cap is attached to the bottle, and the inner surface of the cap, i.e. the surface having grooves that screw onto the baby bottle's neck. In other words, when the cap is removed from the bottle and the handles are removed from the cap, a false wall can be seen provided between the outer surface of the cap and the inner surface, this false wall forming a cavity for the top of the handle to snap up into the screw cap.

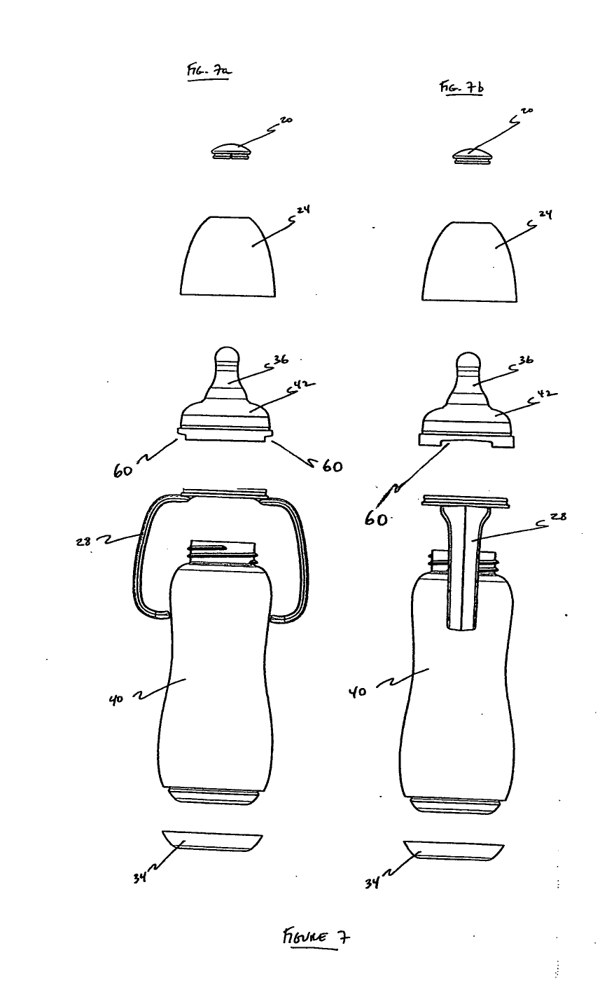

Cap 42 is further provided with two notches or slots 60, as shown in FIG. 7. Each notch or slot 60 is a cut-away section on the side of the cap, at the cap's bottom. This section is shaped and sized such that the top of each gripping arm 50 of handle 28 can fit into the slot 60. Preferably two notches are provided with the second notch being approximately 180 degrees away from said first notch along the circumference of the cap. Alternatively, a cap can be provided with one notch therein, or with three or more notches, as desired, the number of notches preferably corresponding to the number of handles.

To assemble the handle 28 and cap 42, ring 54 of handle 28 is inserted into recess 58 of cap 42 to snap into and form a secure fit between the handle 28 and the cap. Ring 54 is sized and shaped to mate with recess 58, and the top of each gripping arm 50 is sized and shaped to fit into slot 60. Once the handle is placed into the cap, the handle and cap snap or “lock” together to form an integral unit which then can be screwed as one piece onto the neck of the bottle.

As a result, using the present invention, the handle is prevented from sliding or spinning around the neck of the baby bottle during use. Likewise, the handle is more securely attached, and is also easier to screw onto the bottle. The present locking construction is in contrast to those baby bottles with handles currently known in the art. In such bottles, handles rotate around the neck of the bottle, making it hard for the consumer to use the bottle and also potentially scratching the bottle's sides.

Moreover, by recessing the handles up into the inside of the screw cap, the present construction cuts down on bacteria and food particles which can become attached to prior ring constructions which rotate around the bottle. In accordance with the present invention, the top portion of the bottle handles are tucked away in a cavity, and the handle tightly attaches to the cap. This tight one-piece construction reduces or prevents the accumulation of food and bacteria that can more easily occur in the two piece designs currently in use.

In a third embodiment of the present invention, a baby bottle is provided having a skirt provided thereon. This skirt consists of a cap placed on the bottom of the bottle. The skirt acts as a reinforcing element, preventing breakage or cracking of the bottom of the bottle when dropped.

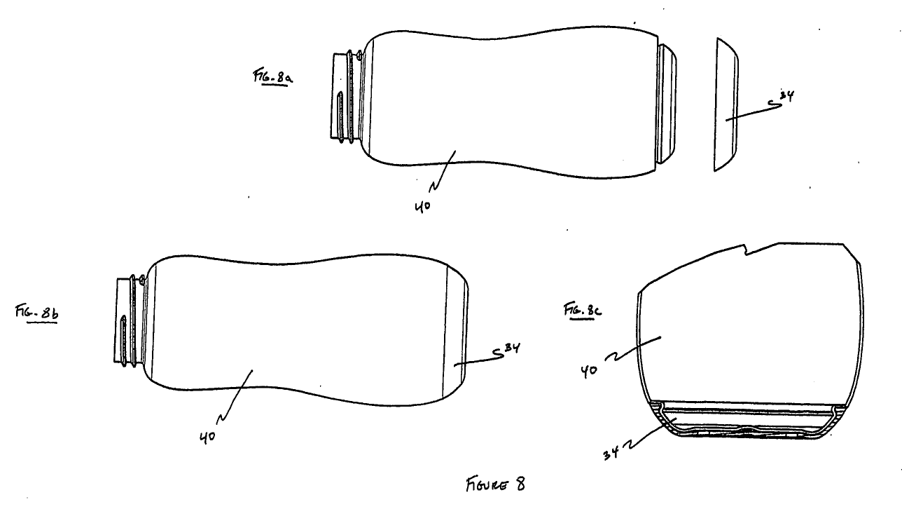

As shown in FIG. 8, skirt 34 consists of a cap-like structure inserted onto the bottom of baby bottle 18. Preferably skirt 34 is more durable in construction or more shock-resistant than the body 40 of the baby bottle. For example, the skirt 34 can be constructed of a more durable substance than the baby bottle and/or can be of a greater thickness than the walls of the body 40 of baby bottle 18. In one embodiment, the skirt consists of a durable, thick plastic, such as a thick layer of polycarbonate.

In accordance with the invention, it is preferred that skirt 34 sit permanently on the bottom of body 40 of a baby bottle 18. When the bottle is dropped on its bottom, the more durable and/or thicker material of the skirt buffers the bottle, absorbing shock and preventing breakage. Thus, the skirt acts as a form of shock absorber for the bottom of the bottle improving the bottle's life and durability. Currently, many bottles split at the bottom of the bottle when dropped. This is a fairly common problem in the art. When a baby bottle is filled approximately halfway to ¾ with liquid and is then dropped, a hydraulic effect is created in which the resulting pressure splits the bottom of the bottle. The snap on base (which is preferably constructed of polycarbonate) serves as a cushion and shock absorber which softens such as blow. This base is preferably snapped tightly onto the bottom of the bottle or molded thereon so as to avoid the base coming loose during use.

Having described the present inventions with regard to specific embodiments, it is to be understood that the description is not meant as a limitation since further embodiments, modifications and variations may be apparent or may suggest themselves to those skilled in the art. It is intended that the present application cover all such embodiments, modifications and variations.

1. An apparatus, comprising:
a cover for the nipple of a baby bottle, said cover comprising a sealing element for sealing a hole at the top of the nipple.

2. An apparatus as claimed in claim 1, wherein said sealing element comprises a button located at the top of said cover.

3. An apparatus as claimed in claim 2, wherein said button is round.

4. An apparatus as claimed in claim 1, wherein said sealing element comprises an approximately dome-like bottom surface.

5. An apparatus as claimed in claim 1, wherein said sealing element comprises a rounded bottom surface, said rounded bottom surface comprising a circumference, said sealing element comprising an annular flange around said circumference.

6. An apparatus as claimed in claim 1, wherein said cover is dimensioned such that said sealing element compresses the nipple of the baby bottle when said cover is attached to the baby bottle.

7. An apparatus as claimed in claim 1, wherein said cover is dome shaped.

8. An apparatus as claimed in claim 1, wherein said apparatus further comprises a baby bottle.

9. An apparatus as claimed in claim 1, wherein said apparatus further comprises a cap for a baby bottle, said cover fitting onto said cap.

10. An apparatus as claimed in claim 1, wherein said sealing icon is a different color than said cover.

11. An apparatus as claimed in claim 1, wherein said sealing element comprises a round upper surface.

12. An apparatus as claimed in claim 1, wherein said sealing element is an integral part of said cover.

13. An apparatus as claimed in claim 1, wherein said sealing element is inserted into said cover.

14. An apparatus as claimed in claim 1, wherein said sealing element comprises an upper surface, and said cover comprises an upper surface, said upper surface of said sealing element being flush with said upper surface of said cover.

15. An apparatus as claimed in claim 1, wherein said sealing element comprises a bottom surface, said cover being dimensioned such that said bottom surface compresses the nipple of a baby bottle when said cover is attached to the baby bottle.

16. An apparatus, comprising:
a cover for the nipple of a baby bottle, said cover being dimensioned such that said cover compresses the nipple of the baby bottle when said cover is affixed to the baby bottle.

17. An apparatus, comprising:
a cap for a baby bottle; and,
a handle for the baby bottle; said cap and said handle being configured such that said handle and said cap attach together.

18. An apparatus as claimed in claim 17, wherein said cap comprises a bottom surface, said bottom surface comprising a recess, and wherein a portion of said handle fits into said recess.

19. An apparatus as claimed in claim 18, wherein the top of said handle fits into said recess.

20. An apparatus as claimed in claim 17, wherein said cap comprises at least one notch in the side of said cap, and wherein a portion of said handle fits into said notch.

21. An apparatus as claimed in claim 17, wherein said cap comprises two notches, each of said two notches being in the side of said cap.

22. An apparatus as claimed in claim 17, wherein said two notches comprise a first notch and a second notch, said second notch being approximately 180 degrees away from said first notch along the circumference of said cap.

23. An apparatus as claimed in claim 17, wherein said cap comprises:
(a) a bottom surface, said bottom surface comprising a recess, a portion of said handle fitting into said recess; and,
(b) at least one notch in the side of said cap, a portion of said handle fitting into said notch.

24. An apparatus as claimed in claim 23, wherein the top of said handle fits into said recess.

25. An apparatus as claimed in claim 23, wherein said cap comprises two notches, at least one notch in the side of said cap.

26. An apparatus as claimed in claim 17, wherein said handle comprises at least one arm.

27. An apparatus as claimed in claim 17, wherein said handle comprises two arms.

28. An apparatus as claimed in claim 20, wherein said handle comprises at least one arm, said arm comprising a top, said top of said arm fitting into said notch.

29. An apparatus as claimed in claim 21, wherein said handle comprises two arms, each of said arms comprising a top, each of said tops fitting into one of said notches.

30. An apparatus as claimed in claim 22, wherein said handle comprises two arms, each of said arms comprising a top, each of said tops fitting into one of said notches.

31. An apparatus as claimed in claim 17, wherein said handle comprises gripping arms, said gripping arms extending down along at least a portion of the length of the baby bottle.

32. An apparatus as claimed in claim 17, wherein said handle comprises a central ring and gripping arms, said gripping arms extending off of said central ring, said central ring fitting into said recess in said cap.

33. An apparatus as claimed in claim 32, wherein said recess is annular.

34. An apparatus as claimed in claim 32, wherein said central ring snaps into said recess.

35. An apparatus as claimed in claim 34, wherein said central ring snaps into said recess.

36. An apparatus as claimed in claim 17, wherein said cap comprises an inner surface, said inner surface comprising grooves for attachment to the neck of a baby bottle.

37. An apparatus as claimed in claim 36, wherein said recess is located between the outer surface of said cap and said inner surface.

38. An apparatus as claimed in claim 32, wherein said cap comprises an inner surface, said inner surface comprising grooves for attachment to the neck of a baby bottle.

39. An apparatus as claimed in claim 38, wherein said recess is located between the outer surface of said cap and said inner surface.

40. An apparatus as claimed in claim 17, wherein said handle snaps into said cap.

41. An apparatus as claimed in claim 17, wherein said handle and said cap are shaped for attachment together in a mating relationship.

42. An apparatus as claimed in claim 17, wherein said apparatus comprises a baby bottle.

43. An apparatus, comprising:
a skirt for a baby bottle, said skirt comprising a protective element for placement on the bottom of the baby bottle to protect against shocks to the bottom of the bottle.

44. An apparatus, comprising:
a baby bottle, said baby bottle comprising a skirt at the bottom of said baby bottle for serving as a protective element to absorb shocks to said bottom of said bottle.

45. An apparatus as claimed in claim 44, wherein said skirt is a approximately cap shaped.

46. An apparatus as claimed in claim 44, wherein the material of said skirt is more shock-resistant than the material of said baby bottle.

47. An apparatus as claimed in claim 44, wherein said baby bottle comprises a wall comprising a thickness, and said skirt comprises a wall comprising a thickness, said thickness of said wall of said skirt being thicker than said thickness of said wall of said baby bottle.

48. An apparatus as claimed in claim 44, wherein said skirt comprises polycarbonate.

49. An apparatus as claimed in claim 44, wherein said baby bottle comprises a bottom, said skirt snapping tightly onto said bottom.

50. An apparatus as claimed in claim 44, wherein said baby bottle comprises a bottom, said skirt being molded onto said bottom.

51. A baby bottle comprising at least two elements selected from the group consisting of: (a) a cover for a baby bottle having a nipple, said cover including a sealing element therein for sealing the orifice at the top of the baby bottle's nipple; (b) a cap for a baby bottle, wherein said cap contains a recess therein for receiving a portion of a handle in a mating relationship; (c) a handle for a baby bottle having a cap, wherein said handle is shaped for attaching to the cap of the baby bottle in a mating relationship; and (d) a skirt for a baby bottle, said skirt comprising a protective element for placement on the bottom of the baby bottle to protect against shocks to the bottom of the bottle.

52. A baby bottle comprising at least three elements selected from the group consisting of: (a) a cover for a baby bottle having a nipple, said cover including a sealing element therein for sealing the orifice at the top of the baby bottle's nipple; (b) a cap for a baby bottle, wherein said cap contains a recess therein for receiving a portion of a handle in a mating relationship; (c) a handle for a baby bottle having a cap, wherein said handle is shaped for attaching to the cap of the baby bottle in a mating relationship; and (d) a skirt for a baby bottle, said skirt comprising a protective element for placement on the bottom of the baby bottle to protect against shocks to the bottom of the bottle.
